(19) United States
(12) Patent Application Publication
(10) Pub. No.: US 2015/0088541 A1
(43) Pub. Date: Mar. 26, 2015

(54) SYSTEM AND METHOD OF USING PERSONALIZED OUTCOME PROBABILITIES TO SUPPORT THE CONSUMER IN COMPARING COSTS AND EFFICACY OF MEDICAL TREATMENTS AND MATCHING MEDICAL PROVIDER WITH CONSUMER

(71) Applicant: UNIVFY Inc., Los Altos, CA (US)

(72) Inventor: Mylene Wei Ming Yao, Los Altos, CA (US)

(73) Assignee: UNIVFY Inc., Los Altos, CA (US)

(21) Appl. No.: 14/497,916

(22) Filed: Sep. 26, 2014

Related U.S. Application Data
(60) Provisional application No. 61/883,184, filed on Sep. 26, 2013.

(51) Int. Cl. G06Q 50/22; G06Q 30/00

(52) U.S. Cl. CPC G06Q 50/22; G06Q 30/00
USPC 705/2

(57) ABSTRACT

Provided herein are methods and systems for implementation and delivery of cost comparisons for medical treatment plans. Included are methods and systems of delivering cost comparison to consumers on a plurality of medical treatments offered by the same medical provider or a plurality of medical treatments offered by a plurality of medical providers with or without analyzing the impact of insurance coverage, payment by cash, credit card, loans, and loan and repayment terms. Also included are methods and systems for matching consumers with medical providers based on cost, financing, consumer characteristics, medical provider attributes, and diagnostic and prognostic criteria.

### CROSS-REFERENCE TO RELATED APPLICATIONS

This application claims priority to and the benefit of co-pending, commonly owned U.S. Provisional Patent Application No. 61/883,184, filed on Sep. 26, 2013, the disclosure of which is incorporated in its entirety herein.

### TECHNICAL FIELD

The present invention relates generally computer-based comparison systems and methods. More specifically, the present invention relates to systems and methods for implementing and delivery cost comparisons for medical treatment plans.

### BACKGROUND OF THE INVENTION

A multitude of efforts is being made—and will likely continue to be made—to move an institutional- or provider-centric healthcare delivery system to a patient-centered system. Among these efforts is the promotion of a “consumer-driven” healthcare by many healthcare stakeholders. Health consumers (hereafter, consumer or consumers) are encouraged to select treatment options, providers, or insurance policies that are best for them. Presumably, in a consumer-driven market, demand for health services that have greater value in terms of benefits and cost to the consumers, either directly or indirectly through health plans or government subsidy, will increase. Health services with greater value and demand are expected to be more competitive, and the resulting consumer-driven healthcare market will deliver more benefits and greater efficiencies to consumers.

However, consumers cannot truly drive healthcare or choose the option that is best for them if they do not know the value—price and efficacy—of each of several treatment options offered by the same medical provider, or of a plurality of medical options offered by a plurality of medical providers. Here, maximizing value means to achieve the best efficacy or outcome for that consumer at a minimal financial, physical, and emotional cost. Efficacy is measured by the probability that a given treatment option will be effective, or have failure, side effects and/or complications; these measures can be reported in terms of improved bodily functions, quality of life, ability to carry out normal functions, or decrease physical or mental suffering. The cost can be reported in terms of the list and sale price of the medical treatment or a series of medical treatments, with or without diagnostics, or in the event of treatment failure or the occurrence of complications, the price of treatment failure, including treating complications or alternative medical options. Efficacy and cost can be provided at incremental levels of personalization by matching simple or complex health profile data specific to the consumer, based on simple references of demographics or advanced analytics.

Consumers will become more proactive in obtaining and demanding measures of efficacy and cost of medical treatments. In order to support the health purchase decision of the consumer, there is an urgent need to help the consumer compare the efficacy of one or a plurality of medical treatment options offered by the same medical provider or the efficacy of one or a plurality of medical treatments offered by a plurality of medical providers.

Consumers would ideally make their healthcare purchase decision based on efficacy and personal preference based on a range of criteria. However, when faced with financial constraints, consumers may consider treatment options or medical providers that have lower effectiveness, if the cost is lower, or if those options are associated with financing options which make it possible for them to access medical treatments that would normally be out of their financial reach.

Consumers who are considering to have medical treatments that are not covered by their medical insurance policy or are only partially covered by insurance, need to decide if they will pay for the non-reimbursed portion by cash, credit card, loan, crowd-funding, a combination of these options, or other financing options. If options other than cash are considered, the terms of those financing options may have a significant impact on the ultimate cost of the medical treatment. Some medical providers may offer special pricing alone or conditional upon the use of certain financing options. Some medical treatment options may be offered at special pricing or in conjunction with financing options.

To make sound financial and health decisions, consumers need a system that helps them to analyze the efficacy and price of the primary medical treatment, plurality of medical treatment options, and medical treatments that may be required upon failure or occurrence of complications of the primary medical treatment, and the ultimate cost after considering financial options and financing terms.

When choosing the medical treatment, a specific financial package for a particular treatment, or medical provider, consumers may also wish to consider other factors such as efficacy that is personalized to their specific health profiles, geographical distance from the medical provider and cost incurred by travels, availability of medical provider in terms of specific dates or the length of a wait list, review of medical provider by other patients, or review by the caregivers or family of other patients.

For many reasons, including the need or preference to improve efficiency, cost-effectiveness of provider or provider's staff workflow, minimize liability, or to improve efficacy by specializing in treating specific types of patients for specific medical condition(s), medical providers may also have preferences or eligibility criteria defining the types of patients that they are willing or prefer to treat, as well as payment plans that they will accept or reject.

For certain medical treatments, patients may consider traveling to receive medical treatment from medical providers that are outside of commutable distance. Patients may desire or ask to communicate with medical providers via telephone, email, screen time, or other modes of communications. Medical providers may also have such preference or requirements.

Medical providers who are far from the consumers' local area may require or prefer a specific type of pre-treatment assessment by a local medical provider to ensure that the consumer qualifies for a certain medical treatment and would not pose unacceptable medical risks.

Currently, some consumers do seek second opinions or choose medical treatment and medical provider from long distance or even from a different country. However, this process is usually time-consuming and often very costly to consumers as they have to identify, contact, and follow up with each medical provider before they are willing to offer the price of medical treatment or accept the consumer. The current process is often inefficient for the medical providers as well, as they have to dedicate time and personnel to learn about and counsel the consumer (e.g. consultation), without knowing if how the consumer will make his or her decision, or without proof that the consumer can even pay for the treatment.

Consumers who are navigating fertility treatments, including in vitro fertilization (IVF) have a great need to access an affordable, single system that compares medical treatments and providers based on treatment efficacy, cost of treatments or treatment packages, financing, and other factors such as consumer review, peer review, eligibility criteria, local medical pre-assessment. Further, matching functions can bring consumers and medical providers that meet one another's eligibility criteria with much greater efficiency or reduced cost and time to both consumers and medical providers.

Currently, the consumer has limited or no method to compare price and efficacy by treatment, medical provider, or other criteria. The information that is currently available is largely descriptive (e.g. description of medical diagnoses and treatments in the form of static medical content or interactive question and answer with medical providers); or qualitative and subjective patient- or peer-review of medical providers that may not inform consumers of treatment efficacy or cost.

Although there are many online, software, or hard copy financial calculators for consumers to perform personal financial planning, or calculate loan or home mortgage refinancing, there is currently no single system or a set of systems that help the consumer compare efficacy of medical treatment in the context of the ultimate cost of the treatment to the consumer by considering his or her health insurance coverage, cost of health insurance, health exchange or any other credits or currency for the exchange of health treatments, upfront and deferred cash payments resulting from credit card payments, debit card payments, institutional and/or personal loans, financing terms, costs of crowd funding, or any other mechanisms of payment or repayment.

### SUMMARY OF THE INVENTION

The present invention provides a system and method of comparing the costs and efficacy of medical treatments to the consumer that overcomes the shortcomings and challenges in the art. The present invention also provides a system and method of matching consumers with medical providers that overcomes the shortcomings and challenges in the art.

In one embodiment of the invention, there is provided a system comprising: (i) a computer platform comprising at least one algorithm designed for comparing and ranking information; and (ii) an interactive user interface that communicates with the computer platform, wherein the interactive user interface comprises: (a) a fertility health profile module comprising a questionnaire pertaining to an individual's fertility goals and reproductive health; (b) a fertility financial profile module comprising a questionnaire pertaining to an individual's insurance and personal finances as they relate to fertility treatments; (c) a fertility treatment module comprising a listing of fertility treatments to be selected by the individual in order of preference; and (d) a fertility treatment provider module comprising a listing of fertility treatment providers to be selected by the individual in order of preference, wherein the computer platform ranks the fertility treatment providers from module (d) from a best to worst match in relation to the fertility treatments selected in module (c) based upon the information provided in modules (a) and (b) and delivers the ranking results to the interactive user interface.

In another embodiment, the ranking results include personalized cost estimates for at least one of the fertility treatments of module (c) based upon information provided in module (b).

In a further embodiment, the interactive user interface provides a recommendation of at least one fertility treatment provider for at least one of the indicated fertility treatments from module (c).

In still another embodiment, the interactive user interface allows the individual to view the fertility treatments provided by at least two fertility treatment providers in a table format.

In another embodiment, the interactive user interface is provided in a secure internet site that communicates with the computer platform via a secure internet connection.

In a further embodiment, the computer platform comprises databases of fertility treatments and fertility treatment providers that are used to populate modules (c) and (d).

In another embodiment, the computer platform further comprises a secure database of information pertaining to data previously entered into the interactive user interface to increase personalization and diversity of the questionnaires of modules (a) and (b) and the lists of modules (c) and (d), wherein module (d) may include fertility treatment rankings entered by prior users of module (d) and prior users may be selected from individuals and fertility treatment providers.

In a further embodiment, the system has a one-way matching interface, wherein a user of the interactive user interface may consent to receive special offers from the fertility treatment providers of module (d).

In another embodiment, the system has a two-way matching interface, wherein a user of the interactive user interface may consent to receive special offers from fertility treatment providers of module (d); and fertility treatment providers of module (d) may actively select or recruit users of the interactive user interface to participate in reduced priced diagnostics or treatment packages based upon the information provided by the user in modules (a) and (b) and the user's selection of fertility treatments from module (c). The two-way matching may be determined by factors selected from the group consisting of: a likelihood that a user will proceed with a recommended fertility treatment within a specified time period; a likelihood that a user will proceed with a recommended fertility treatment provider within a specified time period; a likelihood that the recommended fertility treatment will achieve a user's fertility goals; a probability that a user will discontinue fertility treatments prior to meeting the user's fertility goals; a probability that a user will discontinue fertility treatments prior to completion of a fertility treatment regimen; a probability that a user will default on payments for fertility treatments already provided by a fertility treatment provider; and a probability that a user will default on fertility treatments committed to the user by the fertility treatment provider.

In a further embodiment, the system comprises a ranking interface in module (a), wherein the user ranks each item in the questionnaire according to relative importance and the computer platform uses the user's ranking to assist in the determination of the final ranking of the fertility providers.

In a further embodiment, the system comprises a financial pre-qualification interface based upon the information provided in module (b) of the interactive user interface, wherein pre-qualified users receive personalized treatment options or packages from participating fertility treatment providers of module (d).

In still a further embodiment, the system comprises a fee interface, wherein users of the interactive user interface pay to access one or more of the questionnaires of modules (a), (b), and (c) and to receive rankings of fertility treatment providers and further wherein fertility treatment providers may pay for inclusion into module (d).

Additional advantages and embodiments of the invention will be provided, without limitation, in the detailed description of the invention that is set forth below.

### DETAILED DESCRIPTION OF THE INVENTION

Set forth below is a description of what are currently believed to be preferred embodiments of the claimed invention. Any alternates or modifications in function, purpose, or structure are intended to be covered by the claims of this application. As used in this specification and the appended claims, the singular forms “a,” “an,” and “the” include plural referents unless the context clearly dictates otherwise. The terms “comprises” and/or “comprising,” as used in this specification and the appended claims, specify the presence of stated features, integers, steps, operations, elements, and/or components, but do not preclude the presence or addition of one or more other features, integers, steps, operations, elements, components, and/or groups thereof

Health consumers means consumers, patients, or individuals who are recipients of or who directly or indirectly purchase, for themselves or others, healthcare services including medical diagnostics, medical treatments, surgical treatments, or any services given by health professionals, licensed health facilities; family, guardians, or individuals who are caring for an individual or individuals who are or will be receiving care from health professionals, licensed health facilities.

Health services means diagnostics, medical, surgical, or any other treatments that are provided by licensed health professionals including but not limited to physicians, nurses, nurse practitioners, dentists, psychologists, optometrists, chiropractors, alternative medicine providers such as acupuncturists, therapists, technicians, paramedics and support services related to the co-ordination or procurement of health services, such as care co-ordinators, administrators, account representatives, customer support. Health services may or may not have corresponding CPT codes.

Treatments means a single, one-time health service; ongoing health services; a set of concurrent treatments that aims to obtain a certain health result; a series of sequential treatments that aim to obtain a certain health results; a bundle or package that may or may not include treatments and supportive services required to receive treatments; a set of treatments that includes a primary first-line treatment with or without alternative treatments that will be used if the primary treatment fails, produces suboptimal results, or complications; a set of treatments that includes a primary treatment with or without treatments that are necessary for treatment complications that result from the primary treatment.

Efficacy means a measure of a treatment outcome for an individual that includes one or more of improved bodily functions; improved quality or extension of life; ability to carry out normal or above normal functions; decreased physical, mental, or emotional suffering; or the substitution, replacement, or correction of a defective or flawed bodily function.

Efficacy or any of the above measures can be expressed as the percentage of patients that has a certain positive outcome, complication, side effect, negative outcome, or an outcome in which another treatment or a series of the same treatments, or a set of different treatments, is needed. Efficacy can also be expressed as a distribution curve, histogram, or a table which shows the percentage of patients having a certain level or grade of success or failure in outcome. Efficacy can also be expressed as the percentile of patients that have an outcome above a certain success threshold.

Cost means the price that a consumer would have to pay in exchange for, or to receive, a treatment or health services, unless “cost” is explicitly qualified by “cost to the provider”, “cost to stakeholders”, or any other definition. Cost can be provided in terms of the price or fee that a consumer would have to pay to receive different components of health services that together, constitute a treatment; for example, if a consumer needs knee surgery, he/she may have to pay a fee to the orthopedic surgeon, surgical facility, anesthesiologist, and any anesthetic medicine or diagnostics that are given pre-surgically, during, and after surgery. Each fee can be presented as a separate cost to the consumer, and traditionally, the consumer may have to add them all up to determine what is the total cost of surgery. Alternatively, the cost can be a bundled payment that is a single fee quoted to the consumer by the medical provider, directly or via this invention. The bundled payment encompasses all costs to different individuals and facilities that are involved in providing the knee surgery. The bundle payment may simply be the sum of all the separate costs, or it may have been developed by different pricing mechanism that does not necessarily reflect the cost of each professional or facility fee, but is the result of marketing and cost considerations. The cost may or may not represent the total cost to the consumer which may or may not be reimbursable by the insurance carrier, and costs to third parties such as employers or insurance carriers may be considered separately. In any case, the definition of cost will be specified by the invention.

Medical providers means licensed health professionals who offer or perform health services and treatments; licensed virtual or physical facilities in which treatments or health services are delivered, including inpatient facilities, outpatients facilities, hospitals, hospices, rehabilitation centers, healthcare networks, clinics, surgical centers, mobile facilities, transporters, providers providing house calls, or providers of healthcare during travels.

Medical insurance policy means medical insurance plans paid fully or partially by employer, government, third party credits, the consumer and/or the consumer's family or spouse or partner, in which third party credits include access to health services provided by a state's exchange or any other currency that can be exchanged for health services.

As used herein, the term “medical treatment comparison system” (hereafter, MTCS) means a physical, electronic, wireless, cloud-based, web-based, mobile app-based, TV-streamed, or any hard copy reproductions of the preceding formats, tool that takes data pertaining to health, financial, insurance, geographic, personal preferences and any information relevant to the selection of medical treatment, financial packages or medical provider, and provides an output to show the efficacy of treatments that are being compared, the efficacy of treatments as performed by certain medical providers, the price at which each treatment or treatment-provider is being offered, and the full financial implications of each treatment given the preferred method of payment and insurance policy of the consumer.

As used herein, the term “consumer-provider matching system” (hereafter, CPMS) means a physical, electronic, wireless, cloud-based, web-based, mobile app-based, TV-streamed, or any hard copy reproductions of the preceding formats, tool that takes data pertaining to health, financial, insurance, geographic, personal and treatment preferences and any information relevant to the matching of the consumer with a provider based on criteria or preferences entered by a consumer and medical providers that offer the medical treatments being searched by the consumer.

Within the context of the present invention, health data comprise variables selected from the group consisting of demographic variables (e.g., ethnicity, household income level, education), clinical data (e.g., symptoms, findings on physical examination, medical history, past treatments, past surgeries, medications), and laboratory data. Laboratory data includes without limitation, lab test results pertaining to any bodily fluids, tissue-level data, imaging results, and biomarker test results, which may or may not include genetic markers, genomics, or genetic data extracted from discovery platforms. Examples of tissue-level data includes without limitations, immunoassays, quantitative PCR (qPCR), semi-quantitative measurement of transcriptome by gene expression arrays, or whole-transcriptome sequencing.

A consumer's health data also includes a prediction of treatment outcome that is specific to the consumer based on one predictor, a plurality of predictors, a plurality of predictors that are given certain relative weighting, a prediction model that is specific to a provider's patient population, or a prediction model that represent diverse patient populations. The predicted treatment outcome can be the predicted outcome of a single treatment, a single course of treatment, a series of treatments, or a set of different treatments aimed to work synergistically to target the same medical condition. A consumer's predicted treatment outcome may be expressed as the probability of having a certain outcome, complication, side effect, or need for another treatment, or a series of the same treatments, or a set of different treatments. A consumer may know her predicted treatment outcome from her medical provider, or specific personalized prognostic testing. In the absence of known predictors or prediction model, the predicted treatment outcome may be derived from available descriptive statistical data from a medical provider, reference patient population, medical research literature, or national or other published statistics.

As used herein, the term “de-identified data” refers to data pertaining to a consumer that has been stripped of any identifying information regarding the consumer; “personal identifiers” refers to data pertaining to a consumer that alone, can be used to identify the individual. It will be understood by those of skill in the art that within the context of the present invention, the use and processing of personal identifiers and de-identified data will be in compliance with HIPAA, HITECH, and privacy and consumer laws.

The method of providing cost and efficacy information to the consumer and data required for matching consumers and medical providers may be a platform operated by a web-based application on the public internet; web-based application on an exclusive network; mobile application on a mobile device; a platform accessible at health kiosks located at pharmacies, other types of retail stores, airports, medical facilities; or a device that is specifically designated for accessing efficacy and cost comparison information. An exclusive network can be a private intranet such as one that is exclusive to employees of a company; or an exclusive website accessed by members only, in which membership is defined by purchase of a type of insurance policy, membership to a financial institution, or enrolment based on paid membership or usage of credits given by another entity. In one embodiment, the cost and efficacy information, and data required for matching consumers and medical providers, is specific to the consumer's health data and predicted treatment outcomes.

The method of providing cost and efficacy information to the consumer can also be in the form of a hard copy listing much like a telephone directory from the days before the internet; marketing material like the flyers listing homes for sale, their attributes and sale price; an electronic listing stored on a memory device such as a CD-ROM or thumb drive; or an electronic database stored in a remote server and accessible via web applications, mobile applications or downloadable by purchase like an e-book.

In one embodiment, different types or amounts of information from an MTPS and/or CPMS (hereafter, MTPS/CPMS), or their updates are available to the consumer and provider at different prices or levels of membership. Alternatively, such information may be provided at no cost to providers and/or consumers in various formats differing in organization and search capabilities funded by sponsors such as insurance companies, medical providers, or advertisers.

In another embodiment, the consumer can enter his or her signs and symptoms and/or additional health profile data into an MTPS/CPMS, to search for individual diagnostic tests or diagnostic tests offered as a package by a plurality of medical providers, their efficacy in making a diagnosis, and cost. For example, this method can be used by a consumer or his/her representative to identify the extent of the diagnostics to be selected to identify the medical cause of a wide range of chronic conditions such as chronic fatigue, chronic headache, bloating or bowel abnormalities, facial pain, urinary incontinence, back pain, infertility, previous in vitro fertilization failure; sub-acute conditions such as new onset blood pressure, chest pain, joint pain; acute conditions such as severe abdominal pain, sudden onset chest pain, neurological symptoms suggestive of stroke, or high fever associated with systemic symptoms.

In one embodiment, the MTPS/CPMS takes the health data from the consumer, including health insurance policy information, and with or without diagnostics and/or treatments specified by the consumer. The system then indicates the diagnostics and/or treatments that are wholly or partially covered by the consumer's health insurance policy and ones that are not reimbursable by his/her insurance policy; the cost and efficacy of diagnostics and treatments based on the consumer's personal health data and predicted outcomes; the probability of having each outcome and the cost of each set or package of diagnostics and/or treatments, and the cost and probability of needing certain diagnostics and treatments as a result of the first round of diagnostics and/or treatments. The system will also indicate the types of medical consequences that can result from not pursuing certain diagnostics and/or treatments, the probability of having those medical consequences, and the cost of addressing those medical consequences if they were to arise. The consumer can then choose the diagnostics or treatments, set of diagnostics or treatments, or series of diagnostics or treatments, after being fully informed about his/her specific probability of each major outcome (e.g. positive outcomes such as treatment success, complications, side effects, having the need for an alternative or additional diagnostics/treatments) based on his/her own health data. His/her representative or medical provider can also help him/her use the MTPS/CPMS or use the system's report to counsel the consumer about those risks. There may also be medical professional guidelines that state the minimal necessary diagnostics and/or treatments that are recommended as a reasonable amount of effort to address the medical needs of the consumer.

Alternatively, or additionally, the consumer can enter his or her diagnosis, possible diagnoses and/or prognoses if known, with or without levels of severity, results of prior or ongoing treatments, and any additional data pertaining to her health, personal, and/or financial profiles into an MTPS/CPMS, to search for treatment options or treatment plans or packages, their cost and efficacy, and/or financing options.

In another embodiment, the MTPS/CPMS offers features to refine search to provide efficacy, cost, and recommendations that are personalized by the health, demographic and/or financial profiles of the consumer; his/her preferences such as distance from medical providers, geographic region, cultural and/or language preferences; ratings resulting from consumer or medical professional reviews; insurance policies accepted; financial payment methods accepted; and/or any other attributes of the medical providers that are available.

One embodiment of the MTPS/CPMS focuses on the mutual matching of medical providers and consumers based on criteria established or demanded by each medical provider and consumer. The goals of such mutual matching are to enhance efficacy and lower cost (by maximizing efficiency) by optimizing the degree of specialization of medical providers. Provider-consumer matching may also provide better prediction of efficacy and cost based on a greater volume of cases or consumers that have similar health or health and insurance/finance profiles.

In another embodiment, the MTPS/CPMS provides a mechanism for medical providers and/or consumers to input the diagnostics or treatments, payment methods, and medical providers that they chose, and the results of their selection. This information then becomes part of the database from which future consumers can search and make their selections. Thus, current consumers benefit from data entered by past consumers to increase the diversity of application and accuracy of personalization of search results. In one embodiment, data entered by consumers, providers or health or insurance administrators can also be audited by an independent party to ensure accuracy of the data and the resulting quality of the MTPS/CPMS.

In variations of the above embodiments, searches or usage of the MTPS/CPMS are performed by a family member, medical provider, administrator, or health insurance agent, for or on behalf of the consumer.

In another embodiment, the MTPS/CPMS facilitates one-way or two-way bidding to help medical providers recruit consumers with desired attributes such as types and severity of diagnosis and/or high probability of treatment success. Recruitment of specific types of consumers via overt marketing through MTPS/CPMS, or bidding through reduced price of diagnostics and/or treatment packages can help medical providers that specialize in rare or non-common medical conditions to maintain leadership, volume, expertise, and efficacy in treating those conditions, and can also improve efficiency in terms of staffing and infrastructure costs. Bidding can result in reduced pricing of services offered, or the offer of additional services that are not usually part of the treatment plan. For example, medical providers may offer assistance to co-ordinate travel itinerary or even lodging for consumers who live beyond the commutable distance, combine non-medical spa services with psychotherapy, or provide a session from a life coach with rehabilitation. Medical providers can also use this mechanism to lower cost by locating their facilities in remote areas that have much lower real estate costs and tax burden.

In one embodiment, multiple medical providers can offer close bids to a consumer by a certain timeline or they may offer and re-offer open bids in real-time according to guidelines of the MTPS/CPMS. Bids do not necessarily cause the consumer's selection of treatment or medical provider to be based solely on price, because medical providers that have established high efficacy may offer a price that is higher than others and still be selected by the consumer. A plurality of MTPS/CPMS programs could have different rules. One type of MTPS/CPMS program may require the lowest bid to be selected; another program may allow the consumer to view the bid and still choose the medical provider based on factors other than the bid; and other programs may require the consumer to choose the medical provider that is his/her best match based on criteria submitted by both the consumer and medical provider.

The consumer may also offer to participate in certain services such as marketing focus groups or clinical trials for a reduced price or additional benefits not usually offered with certain diagnostics or treatments. The posting and offering of such services by medical providers or collaborating industry groups would be subject to approval by institutional review boards and other compliance mechanisms. The inclusion of these options in MTPS/CPMS platforms can maximize transparency, efficiency of compliance checks, and lower the traditional cost and barriers to focus group and clinical trial recruitment, including non-financial barriers such as cultural, educational, geographical barriers to obtaining this type of information.

In one embodiment, the MTPS/CPMS is integrated with other systems by hardwiring, data transfer via internet or intranet, to facilitate and expand their utility. For example, the MTPS/CPMS can be integrated with decision support (DS) and/or electronic health systems (EHS) with the necessarily encryption and security, to inhale data pertaining to the consumer's health profile, diagnostics results, diagnoses, prognoses, past medical treatments, interactions with other medical providers, to provide information required by the MTPS/CPMS to perform the requested tasks to compare effectiveness and cost for one or a plurality of medical treatments and one or a plurality of medical providers.

In another embodiment, the MTPS/CPMS is integrated with databases containing information about the educational and professional profiles of medical providers or features of medical facilities to inhale data that is relevant or required to match consumers with medical providers.

In another embodiment, MTPS/CPMS is integrated with databases of clinical research literature such as PubMed or the National Library of Medicine-National Institute of Health, or other sources of medical content, including multimedia content, interactive learning materials, and videos, to provide useful references to medical treatments and/or medical providers being compared or matched in MTPS/CPMS.

In another embodiment, MTPS/CPMS is integrated with databases that contain past payment records of consumers to provide rating on historical timeliness of payments of medical bills, debts, history of delinquent payments or indication of credit rating of consumers to medical providers or as eligibility criteria to be matched, to be given cost comparison information, or to adjust pricing.

In one embodiment, the MTPS/CPMS is applied to providers offering and/or consumers seeking elective or semi-elective surgical treatments including orthopedic surgery, plastic surgery, oro-maxillary surgery, fertility preservation for ovarian aging, infertility treatment, eye surgery, gastroplasty, surgery for to remove primary cancer or malignant tumor, palliative surgery, vascular surgery, neurosurgery, fertility preservation prior to cancer treatment, gastro-intestinal surgery, cardiac surgery or any endoscopic, laparoscopic surgery or laparotomy.

In one embodiment, the MTPS/CPMS is applied to providers offering and/or consumers seeking physiotherapy, occupational therapy, chemotherapy, radiation treatment, psychotherapy, psychiatric counseling, preventative treatment or counseling, walk-in clinic services, primary care, surgery, obstetrics and gynecology care, pediatric care, neonatal care, palliative care, rehabilitative care, geriatric care, or all medical specialties.

In one embodiment, the MTPS/CPMS supports consumers that are seeking medical treatments or comparing cost of medical treatments offered by a plurality of medical providers in different countries, and/or facilitates matching of medical providers and consumers from different countries. The MTPS/CPMS is multilingual, and/or offers translation services, transcriptional services, transfer or organization of health data to facilitate the comparison, sorting, and ranking of effectiveness and price with or without personalization of outcome probabilities. Ranking of medical providers or treatments can be performed by the MTPS/CPSM based on individual factors such as probability of positive outcomes, treatment success, probability of complications, the need to have an alternative treatment, average cost, and cost that is personalized based on the consumer's health data and probability of various outcomes, can be ranked individually, or be compiled into one composite score that may or may not include ratings from other consumers, ratings from other medical providers, the number of treatments performed each year or month, percent of market share for that particular treatment or that particular medical specialty in that country, region or the world. Another factor that may be indicated by the MTPS/CPSM is what percentage of the patients being treated by a medical provider is from its local region, non-commutable but within the same country or state, or from another country or continent, and whether the probability of success or complications differs for foreign consumers who may have different medical conditions subtypes compared to local consumers.

Although this invention is designed to serve consumers, third party payers and insurance carriers may utilize it by providing credits of cash or other value to their policy holders (who are also consumers) for using treatments and/or providers referred by MTPS/CPSM that are of greater value (e.g. efficacy and cost) than the medical providers and treatments typically offered by the insurance carriers. On the other hand, insurance carriers can also establish their own standards with usage of MTPS/CPSM by pre-approving certain treatments and medical providers, or treatment-medical provider combinations that they have determined to be of great value and meet their safety and efficacy standards.

In another embodiment, enterprise and corporate customers, including third party payers and insurance carriers, may ask to have a customized MTPS/CPSM that utilizes certain databases that are proprietary or not typically available, or to use the MTPS/CPSM to address specific needs of the company, or the clients of the company which may qualify as consumers.

In another embodiment, the MTPS/CPMS provides longitudinal feedback to compile, sort, and organize reviews by consumers, and with permission, facilitates authentic question and answer by consumers about their experience while protecting their anonymity.

In one embodiment, the MTPS/CPMS allows the consumer to enter his/her insurance carrier information, and calculates the amount of out-of-pocket cost for treatments, and prompts the consumer to enter the amount that will be paid by donation by a non-profit, crowd-funding, for-profit such as an employer, or a personal source, and then calculates the resulting balance to be paid by the consumer via cash, credit card, other forms of financing from a financial institution. Payment from multiple sources can be facilitated by the MTPS/CPMS, so that each source receives correct and timely documentation for tax filing and other accounting purposes and to reduce the amount of logistics required to assemble one large payment from multiple sources. In the case in which a consumer chooses or considers to travel to a foreign country to obtain treatment, the MTPS/CPMS will provide the cost in the medical provider's country's currency, the equivalent cost in the consumer's country's currency, and/or the equivalent amount in a third country's currency, with the third country serving as a reference. The MTPS/CPMS can serve as a collection service when health services and treatments are being marketed and sold internationally.

In another embodiment, the MTPS/CPMS serves to provide efficacy and cost comparison for health services and treatments offered by medical providers in different countries to consumers who are considering to obtain medical treatment in a foreign country. The MTPS/CPMS can also provide audited information related to professional credentials and licensing, and facility licensing of medical providers and local quality assurance benchmarks so that consumers who are unfamiliar with a foreign country's healthcare licensing system can seek care with greater confidence and safety.

In one embodiment, consumers can request, purchase or subscribe to additional services provided by CPMS/MTPS to have a consultation with a CPMS/MTPS officer by phone, email, video-conference, or live meeting, to have the CPMS/MTPS results explained via live question and answer, and to request the CPMS/MTPS perform a customized search for very specific information that may or may not be easily searched by the consumer. The consumer could ask for a customized search to be developed with specific criteria in addition to those offered on the usual CPMS/MTPS that is searchable via public internet or private membership.

The current invention can be applied to help consumers who are seeking infertility care or in vitro fertilization (IVF) to identify the medical provider, treatment package, and if pricing package with or without financing. The CPMS asks the consumer for personal, demographic, financial, and health data such as date of birth or age; current provider; insurance plan, desired IVF treatment (as an example); predicted probability of having a successful IVF based on her current provider's opinion, online IVF success prediction testing, and/or national average success rate based on age; pricing packages to be considered; geographical regions to be considered or excluded.

The CPMS uses the above information to retrieve and show a list of treatments or treatment packages and their corresponding provider, unit price, the predicted probability of having one or more failed treatment, and the associated price of additional treatment or alternative treatment; and the actual fees after taking into account the consumer's preferred payment method or combination of payment methods, which can include one or more of partial insurance coverage or reimbursement, cash, credit card, and loan. If the consumer chooses to pay part or all of the fees with credit card and/or loan, then the CPMS will ask her for the loan terms, such as interest rate, the number of months of the loan, and repayment conditions.

Alternatively, if the CPMS is linked to the database containing information about lenders or financing programs, it will ask for the names of the financing or loan programs, retrieve the loan terms details, and use them to calculate the actual fees that will incur.

The consumer can request to include, exclude or filter the list with additional criteria including countries, states, cities, towns, number of treatments performed by the medical provider (e.g. physician and/or facility), descriptive statistics of treatment success, personalized prediction of treatment success, distribution of health profiles of patients who have been treated by that medical provider (e.g. “are they patients like me”), similarities of the medical provider's patient population to the consumer herself, financial profiles of patients treated by that medical provider, languages spoken by the medical provider and his/her staff, acceptance by medical provider of medical insurance plans or direct payment by loan and finance programs, percentage of patients that require additional or alternative treatments after the primary treatment of interest, probability of complications, and rating by patients of that medical provider.

In one embodiment, the MTPS/CPMS shows IVF treatment packages includes the packaging of one or more treatments that are the same or different for an upfront payment or committed payment that costs less than the price of purchasing each IVF treatment individually. For example, a two-IVF treatment package that includes two IVF treatments may cost $16,000 compared to the per-IVF treatment price of $10,000 if purchased separately.

Here, one IVF treatment may or may not include evaluation of the patient and prescription of injected hormones (prescription drug) for ovarian stimulation, monitoring of ovarian stimulation by serial ultrasound imaging of ovaries and blood tests (e.g. serum levels of estradiol or other hormonal panel), serial reassessments of dosage of hormonal injections, determination of hormonally-induced maturation of ovarian follicles by medications, ultrasound-guided oocyte retrieval, performance of semen analysis and sperm wash, in vitro preparation and handling of oocytes and sperm to facilitate fertilization or intracytoplasmic sperm injection to reach the two-pronuclei stage of embryo development, in vitro culture of embryos with or without imaging or monitoring, review of embryo morphology and quality, selection and transfer of one or more embryos with or without further assessment of embryo viability through pre-implantation genetic screening, pre-implantation genetic diagnosis, or review of embryo morphology during development, cryopreservation of excess embryos, subsequent thaw and in vitro culture of cryopreserved embryo(s), transfer of thawed embryos to the uterus, follow up of the consumer with any required prescription medication and serial blood tests and ultrasound to detect and/or follow early pregnancy, and treatment and/or monitoring of complications of early pregnancy (e.g. ectopic pregnancy, biochemical pregnancy, clinical pregnancy loss) and/or ovarian stimulation (e.g. ovarian hyperstimulation syndrome). Typically, the cost or prescription medication is not included in the price of IVF treatment, but a third party may package the cost of IVF and prescription medication together into one IVF package. The treatment package may or may not include any of the above procedures but the items that are included or excluded will be explicitly stated in the MTPS/CPMS, so that the consumer could compare “apples to apples”. Note: These medical and laboratory procedures are established procedures in IVF, and do not constitute any novelty or invention in and of themselves. They are listed here to demonstrate the possible scope of “a single IVF treatment”.

Another IVF package being compared in the MTPS/CPMS may be a risk-share program in which a consumer pays a price for an IVF package that may include two or three IVF treatments, and guarantees a certain outcome. The guaranteed outcome may be a clinical pregnancy, a pregnancy that lasts at least till second trimester or a specific clinical stage of pregnancy, or live birth. If the guaranteed outcome does not occur after the specified number of treatments, the risk-share program entitles the consumer to receive a refund that is a specified percentage of the price of the IVF package. Risk-share programs may be offered by a network of providers, a single provider, or through third parties.

The MTPS/CPMS will show the consumer the probability of needing a second and/or third IVF, and also the probability of not having a baby after three IVF treatments, based on the predicted probability of having a baby in one IVF treatment as entered by the consumer based on her provider's opinion, or a personalized prediction that she obtained from doing an online IVF success prediction test. If either of these sources of prediction is not available, the consumer can enter health data such as date of birth, so that the MTPS/CPMS can retrieve an age-based prediction of IVF success based on national average IVF success probabilities for her age group. If the latter is used, the MTPS/CPMS will inform the consumer of the inferior quality of the IVF prediction that is based on national statistics, and how she could obtain a prediction that is more accurate and personalized. There can also be an option to request the MTPS/CPMS to search a separate analytics engine that will perform online personalized prediction of IVF success as an integrated service or added service at an additional cost.

Importantly, the MTPS/CPMS will not only show the cost of IVF treatments or IVF treatment packages as offered by different providers, but it will also show the total cost of each IVF treatment/treatment package after accounting for all financing terms, and it will show her personalized probabilities of needing a second IVF treatment and having a baby in that second IVF treatment in the event that the first IVF treatment is unsuccessful; her personalized probabilities of needing a third IVF treatment and having a baby in that third IVF treatment in the event that the first and second IVF treatments are unsuccessful; her personalized probability of having no baby after three or a specified number of IVF treatments; the cost in terms of price offered by medical provider(s) and actual cost after accounting for financing terms of alternative options to have a baby, including IVF treatment with donor egg, gestational carrier, donor sperm, surrogates, embryo adoption, adoption of a baby or child, and the success and failure rates of those options. These features of the MTPS/CPMS are critical for supporting consumers in understanding the benefits and cost of IVF treatments, the plurality of IVF treatment packages, and their financing options. In one embodiment, the present invention is directed to a method to facilitate consumer selection of one or more fertility services, providers and/or fertility centers, to meet her personal fertility goals by comparing the cost, quality and effectiveness of a plurality of fertility services, providers and/or fertility centers, comprising one or more of the following features: (a) having the consumer enter her personal fertility goals for obtaining one or more fertility services; (b) having the consumer create a health profile by entering information belonging to the group comprising general health data, reproductive health data, probability of having a success fertility treatment; (c) having the consumer create a financial health profile by entering information belonging to the group comprising health insurance carrier, insurance plan, insurance policy, personal financial credit score, and generating the likelihood that she can or will pay for fertility services based on data from her financial health profile, health profile and personal fertility goals; and (d) educating the consumer regarding the range of fertility services available and then having the consumer indicate the types of fertility services that she is willing to consider; (e) having the consumer create her preferences profile by entering information belonging to the group comprising her preferences for geographical location of provider, desired attributes of provider, her budget for fertility services, and methods of payment for fertility services; (f) showing the consumer the choices of fertility services, and providers and/or centers offering those fertility services; (g) allowing the consumer to view the provider profile of each provider; (h) allowing the consumer to view the center profile of each fertility center; (i) showing the consumer a ranking of providers and/or fertility centers from the best to worst match for the consumer based on one or more metrics, wherein (A) the fertility services, providers and centers are ranked in the order of best to worst match for the consumer based on one or more of the group comprising the consumer's health profile, goals for the fertility services, and her preferences profile, (B) the ranking is based on weighting of the consumer's health profile, goals for the fertility services, and her preferences profile based on the most cost-effective way to achieve the consumer's fertility goals, and (C) the ranking is based on a personalized weighting of the consumer's health profile, goals for the fertility services, and her preferences profile, and this personalized weighting is generated by asking the consumer to rank or grade the relative importance of each of the consumer's health profile, goals for the fertility services, and her preferences profile, and/or each factor within the consumer's health profile, goals for the fertility services, and her preferences profile; (j) allowing the consumer to view at least two fertility services, providers and/or centers in a visual table that compares attributes of fertility services, providers, and/or centers belonging to the group comprising cost, quality, probability of treatment success and/or failure, probability of requiring additional services to meet the consumer's fertility goals, and one or more piece of information from the provider profile and/or center profile; (k) giving a recommendation of at least one of fertility services, provider, or center, to the consumer based on the ranking generated in feature (i); (l) allowing one or more of the steps from 1a to k to be executed for one or more consumers, one or more providers, and/or one or more fertility centers without charge; and (k) charging one or more levels of fees to one or more consumers, one or more providers, and/or one or more fertility centers for access to the services resulting from features (a) to (k).

In another embodiment, the features of (a) to (k) described above are used for the following: (1) the consumer is a human being belonging to the group comprising a female that has a male partner, a female that has a female partner, a female that is single and has no partner, a male that has a female partner, a male that has a male partner, a male that is single and has no partner; (2) the consumer's personal fertility goals in Step 1c for obtaining one or more fertility services belong to the group comprising her desire to start having one or more children as soon as possible or sometime in the future, the number of children she desires to have, the time period over which she plans to have these children, and whether she has identified a consenting male partner to provide the sperm for her fertility service or if she plans to use donor sperm; (3) the fertility services belong to the group comprising fertility diagnostic testing, ovarian reserve testing, using predictive analytics to determine the probability of having a successful treatment, ovulation induction with oral or injected medication(s), superovulation with oral or injected medication(s), superovulation and intrauterine insemination, intrauterine insemination with sperm from male partner or donor, and in vitro fertilization (IVF); (4) fertility diagnostic testing belongs to the group comprising medical history and physical examination of the consumer and her partner, hysteroscopy, laparoscopy, endometrial biopsy, ultrasound or other imaging tests, semen analysis, evaluation of fallopian tubes or hysterosalpingogram or other tests, immunologic testing, infectious disease testing, blood tests to evaluate hormonal profile, ovulatory disruptions, ovarian reserve; (5) IVF can be performed with one or more of the services belonging to the group comprising intracytoplasmic sperm injection (ICSI), assisted hatching, minimal ovarian stimulation, standard ovarian stimulation, new protocols of ovarian stimulation, cryopreservation of one or more oocytes, cryopreservation of one or more embryos, cryopreservation of one or more embryos at any time point during in vitro culture, cryopreservation of one or more embryos at the blastocyst stage, the transfer of one or more fresh embryos to the consumer's uterus, the transfer of one or more embryos that have been cryopreserved and thawed to the consumer's uterus, one or more embryos are cultured in conventional incubator, one or more embryos are monitored by time-lapse microscopy during in vitro culture, one or more embryos are evaluated by preimplantation genetic screening or preimplantation genetic diagnosis, one or more embryos are analyzed by whole genome sequencing or other genetic analysis, the culture media of one or more embryos are analyzed by biochemical methods to assess viability or likelihood of euploidy; (6) fertility services belong to the group comprising the use of a female donor's eggs in IVF, transfer of one or more embryos from a donor or donor couple, the use of donor sperm in IVF, the transfer of one or more embryos to one or more gestational carriers, and a combination of one or more of the above; (7) the probability of having a successful fertility treatment can result from the group comprising the professional opinion of the provider, data analytics offered by the provider, data analytics given by a third party directly to the consumer or through a provider, information from websites including the national registry website; (8) the provider profile contains information from the group comprising the provider's personality, religion, fertility treatment philosophy, languages spoken, and professional qualifications; professional work arrangements with one or more fertility centers; indications of local, national, and international reputation of the provider; the demographics of patients served by the provider types and frequency of fertility services performed by the provider; types of payment methods, insurance carriers and/or insurance plans accepted by the provider; the provider-specific cost of each fertility service, set of fertility services, or potential sets of fertility services required to reach the consumer's fertility goals; (9) the center profile contains information from the group comprising the fertility center's history; geographical locations; providers; types, volumes, and frequency of fertility services performed by the center; types of payment methods accepted by the center; insurance carriers and/or insurance plans accepted by the center; indications of local, national, and international reputation of the center; the demographics of patients served by the center; quality measures of the center's facilities; the center's success or effectiveness rates for one or more fertility services and the number of each type of fertility services rendered per year; organizational or corporate structure of the fertility center; efficiency measures of the center; and the center's investment in innovations and facility improvements; the center-specific cost of each fertility service, set of fertility services, or potential sets of fertility services required to reach the consumer's fertility goals;

In a further embodiment of the invention, one or more items in the consumer health profile, consumer financial health profile, consumer's goals for fertility health services, fertility health services accepted by consumer, consumer's preferences profile, can be entered directly by the consumer, provider, an agent of the consumer, or an administrator of the provider through a web-based application, digital device, hardcopy submission, or transmitted from the consumer's, provider's, or third party database through web-, wireless, or other digital communications methods.

In another embodiment of the invention, the matching of feature (i) is a two-way match for one or more consumers and one or more providers and/or centers based on preferences given by consumer in the consumer profile and preferences given by provider and/or center in the provider profile and/or center profile. The preferences given by provider/center in the provider and/or center profiles may belong to the group comprising consumer's fertility health profile, fertility diagnosis, required services, fertility goals, desired budget, financial health profile, and consumer preferences. The two-way matching of consumer and provider and/or center may be conducted or offered only for consumers and providers/centers that request and consent to this service. Consumers that request and consent to the two-way match may be offered a lower price for the fertility services by one or more provider and/or center compared to the price for the same services offered to consumers that do not request or consent to the two-way matching.

In a further embodiment of the invention, consumer can be pre-qualified based on her financial health profile and rewarded with special pricing offered by one or more providers to pre-qualified consumers.

In another embodiment, the cost of fertility services is personalized to each consumer based on one or more of her fertility health profile, probability of meeting her fertility goals within a specified budget and a specified time period; financial health profile, preferences, and pre-qualifications mentioned in claim 7.

In a further embodiment, the methods and features described herein are executed through secured direct access by the consumer, provider, center, and payer to a web-based application, or secured transmission of data from one or more databases containing the required info of one or more of the group comprising consumer, provider, center, and payer.

In yet a further embodiment, access to information by the authorized humans or databases belonging to the group comprising consumer, provider, and center, is limited by the role of each human or database and/or the level of membership of each human or database.

In another embodiment of the invention, there is provided a method to increase the efficiency of the interactions between one or more consumers with one or more provider or center selected by one or more consumers, towards achieving her personal fertility goals by providing a two-way match to recommend and facilitate consumer selection of one or more fertility services, providers and/or fertility centers, based on profiles and preferences provided by both the one or more consumers and the one or more providers and/or centers, wherein efficiency as a function of efficacy, cost to consumer, and cost to provider and/or center is measured by one or more of the group comprising: (I) the likelihood of the consumer to proceed with the recommended fertility services within a pre-specified period of time, and the likelihood that taking the recommended fertility services with the recommended provider and/or center within a pre-specified period of time will result in meeting the consumer's fertility goals; (II) the probability that a consumer will discontinue fertility services after the selected provider and/or center starts providing one or more fertility services and before meeting her fertility goals; and (III) the probability that the consumer will default on payments for fertility services already provided or committed to consumer by the provider or center.

The efficiency of the method may have one or more of the following features: (A) having the consumer enter her personal fertility goals for obtaining one or more fertility services; (B) having the consumer create a health profile by entering information belonging to the group comprising general health data, reproductive health data, probability of having a success fertility treatment; (C) having the consumer create a financial health profile by entering information belonging to the group comprising health insurance carrier, insurance plan, insurance policy, personal financial credit score, and generating the likelihood that she can or will pay for fertility services based on data from her financial health profile, health profile and personal fertility goals; (D) educating the consumer regarding the range of fertility services available and then having the consumer indicate the types of fertility services that she is willing to consider; (E)having the consumer create her preferences profile by entering information belonging to the group comprising her preferences for geographical location of provider, desired attributes of provider, her budget for fertility services, and methods of payment for fertility services; (F) showing the consumer the choices of fertility services, and providers and/or centers offering those fertility services; (G) allowing the consumer to view the provider profile of each provider; (H) allowing the consumer to view the center profile of each fertility center; (I) showing the consumer a ranking of providers and/or fertility centers from the best to worst match for the consumer based on one or more metrics, wherein the ranking is performed based on one or more of (1) the weighting of fertility services, providers and centers in the order of best to worst match for the consumer based on one or more of the group comprising the consumer's health profile, goals for the fertility services, and her preferences profile, (2) the weighting of the consumer's health profile, goals for the fertility services, and her preferences profile based on the most efficient way to achieve the consumer's fertility goals, and (3) the personalized weighting of the consumer's health profile, goals for the fertility services, and her preferences profile, and this personalized weighting is generated by asking the consumer to rank or grade the relative importance of each of the consumer's health profile, goals for the fertility services, and her preferences profile, and/or each factor within the consumer's health profile, goals for the fertility services, and her preferences profile; (J) allowing the consumer to view at least two fertility services, providers and/or centers in a visual table that compares attributes of fertility services, providers, and/or centers belonging to the group comprising cost, quality, probability of treatment success and/or failure, probability of requiring additional services to meet the consumer's fertility goals, and one or more piece of information from the provider profile and/or center profile; (K) giving a recommendation of at least one of fertility services, provider, or center, to the consumer based on the ranking generated in step (i); (L) conducting a two-way match for one or more consumers and one or more providers and/or centers based on preferences given by consumer in the consumer profile and preferences given by provider/center in the provider profile/center profile, wherein (a) the preferences given by provider/center in the provider/center profiles belong to the group comprising consumer's fertility health profile, fertility diagnosis, required services, fertility goals, desired budget, financial health profile, and consumer preferences, (b) the two-way matching of consumer and provider/center is conducted or offered only for consumers and providers/centers that request and consent to this service, (c) consumers that request and consent to the two-way matching are offered a lower price for the fertility services by one or more provider/center compared to the price for the same services offered to consumers that do not request or consent to the two-way matching, (d) the consumer can be pre-qualified based on her financial health profile and rewarded with special pricing offered by one or more providers to pre-qualified consumers; (M) allowing one or more of the steps from 1a to l to be executed for one or more consumers, one or more providers, and/or one or more fertility centers without charge; and (N) charging one or more levels of fees to one or more consumers, one or more providers, and/or one or more fertility centers for access to the services resulting from steps (A)-(L).

Features (A)-(L) as described above may be used for one or more of the following: (i) the consumer is a human being belonging to the group comprising a female that has a male partner, a female that has a female partner, a female that is single and has no partner, a male that has a female partner, a male that has a male partner, a male that is single and has no partner; (ii) the consumer's personal fertility goals in Step 1c for obtaining one or more fertility services belong to the group comprising her desire to start having one or more children as soon as possible or sometime in the future, the number of children she desires to have, the time period over which she plans to have these children, and whether she has identified a consenting male partner to provide the sperm for her fertility service or if she plans to use donor sperm; (iii) the fertility services belong to the group comprising fertility diagnostic testing, ovarian reserve testing, using predictive analytics to determine the probability of having a successful treatment, ovulation induction with oral or injected medication(s), superovulation with oral or injected medication(s), superovulation and intrauterine insemination, intrauterine insemination with sperm from male partner or donor, and in vitro fertilization (IVF); (iv) fertility diagnostic testing belongs to the group comprising medical history and physical examination of the consumer and her partner, hysteroscopy, laparoscopy, endometrial biopsy, ultrasound or other imaging tests, semen analysis, evaluation of fallopian tubes or hysterosalpingogram or other tests, immunologic testing, infectious disease testing, blood tests to evaluate hormonal profile, ovulatory disruptions, ovarian reserve; (v) IVF can be performed with one or more of the services belonging to the group comprising intracytoplasmic sperm injection (ICSI), assisted hatching, minimal ovarian stimulation, standard ovarian stimulation, new protocols of ovarian stimulation, cryopreservation of one or more oocytes, cryopreservation of one or more embryos, cryopreservation of one or more embryos at any time point during in vitro culture, cryopreservation of one or more embryos at the blastocyst stage, the transfer of one or more fresh embryos to the consumer's uterus, the transfer of one or more embryos that have been cryopreserved and thawed to the consumer's uterus, one or more embryos are cultured in conventional incubator, one or more embryos are monitored by time-lapse microscopy during in vitro culture, one or more embryos are evaluated by preimplantation genetic screening or preimplantation genetic diagnosis, one or more embryos are analyzed by whole genome sequencing or other genetic analysis, the culture media of one or more embryos are analyzed by biochemical methods to assess viability or likelihood of euploidy; (vi) fertility services belong to the group comprising the use of a female donor's eggs in IVF, transfer of one or more embryos from a donor or donor couple, the use of donor sperm in IVF, the transfer of one or more embryos to one or more gestational carriers, and a combination of one or more of the above; (vii) the probability of having a successful fertility treatment can result from the group comprising the professional opinion of the provider, data analytics offered by the provider, data analytics given by a third party directly to the consumer or through a provider, information from websites including the national registry website; (viii) the provider profile contains information from the group comprising the provider's personality, religion, fertility treatment philosophy, languages spoken, and professional qualifications; professional work arrangements with one or more fertility centers; indications of local, national, and international reputation of the provider; the demographics of patients served by the provider types and frequency of fertility services performed by the provider; types of payment methods, insurance carriers and/or insurance plans accepted by the provider; the provider-specific cost of each fertility service, set of fertility services, or potential sets of fertility services required to reach the consumer's fertility goals; (ix) the center profile contains information from the group comprising the fertility center's history; geographical locations; providers; types, volumes, and frequency of fertility services performed by the center; types of payment methods accepted by the center; insurance carriers and/or insurance plans accepted by the center; indications of local, national, and international reputation of the center; the demographics of patients served by the center; quality measures of the center's facilities; the center's success or effectiveness rates for one or more fertility services and the number of each type of fertility services rendered per year; organizational or corporate structure of the fertility center; efficiency measures of the center; and the center's investment in innovations and facility improvements; the center-specific cost of each fertility service, set of fertility services, or potential sets of fertility services required to reach the consumer's fertility goals.

In a further embodiment of the invention, one or more items in the consumer health profile, consumer financial health profile, consumer's goals for fertility health services, fertility health services accepted by consumer, consumer's preferences profile, can be entered directly by the consumer, provider, an agent of the consumer, or an administrator of the provider through a web-based application, digital device, hardcopy submission, or transmitted from the consumer's, provider's, or third party database through web-, wireless, or other digital communications methods.

In another embodiment of the invention, the cost of fertility services is personalized to each consumer based on one or more of her fertility health profile, probability of meeting her fertility goals within a specified budget and a specified time period; financial health profile, preferences, and pre-qualifications.

In yet a further embodiment of the invention, the features described herein are executed through secured direct access by the consumer, provider, center, and payer to a web-based application, or secured transmission of data from one or more databases containing the required info of one or more of the group comprising consumer, provider, center, and payer.

In yet another embodiment of the invention, access to information by the authorized humans or databases belonging to the group comprising consumer, provider, and center, is limited by the role of each human or database and/or the level of membership of each human or database.

While the invention has been described in conjunction with the embodiments set forth above, the foregoing description is intended to illustrate and not limit the scope of the invention. Further, the embodiments set forth herein are not exhaustive and modifications and variations of the invention will be apparent to those of ordinary skill in the art without departing from the scope and spirit of the invention.

I claim:

1. A system comprising:
(i) a computer platform comprising at least one algorithm designed for comparing and ranking information; and
(ii) an interactive user interface that communicates with the computer platform, wherein the interactive user interface comprises:
(a) a fertility health profile module comprising a questionnaire pertaining to an individual's fertility goals and reproductive health;
(b) a fertility financial profile module comprising a questionnaire pertaining to an individual's insurance and personal finances as they relate to fertility treatments;
(c) a fertility treatment module comprising a listing of fertility treatments to be selected by the individual in order of preference; and
(d) a fertility treatment provider module comprising a listing of fertility treatment providers to be selected by the individual in order of preference,
wherein the computer platform ranks the fertility treatment providers from module (d) from a best to worst match in relation to the fertility treatments selected in module (c) based upon the information provided in modules (a) and (b) and delivers the ranking results to the interactive user interface.

2. The system of claim 1, wherein the ranking results include personalized cost estimates for at least one of the fertility treatments of module (c) based upon information provided in module (b).

3. The system of claim 1, wherein the interactive user interface provides a recommendation of at least one fertility treatment provider for at least one of the indicated fertility treatments from module (c).

4. The system of claim 1, wherein the interactive user interface allows the individual to view the fertility treatments provided by at least two fertility treatment providers in a table format.

5. The system of claim 1, wherein the interactive user interface is provided in a secure internet site that communicates with the computer platform via a secure internet connection.

6. The system of claim 1, wherein the computer platform comprises databases of fertility treatments and fertility treatment providers that are used to populate modules (c) and (d).

7. The system of claim 1, wherein the computer platform further comprises a secure database of information pertaining to data previously entered into the interactive user interface to increase personalization and diversity of the questionnaires of modules (a) and (b) and the lists of modules (c) and (d).

8. The system of claim 7, wherein module (d) includes fertility treatment rankings entered by prior users of module (d).

9. The system of claim 8, wherein the prior users are selected from individuals and fertility treatment providers.

10. The system of claim 1, further comprising a one-way matching interface, wherein a user of the interactive user interface may consent to receive special offers from the fertility treatment providers of module (d).

11. The system of claim 1, further comprising a two-way matching interface, wherein a user of the interactive user interface may consent to receive special offers from fertility treatment providers of module (d); and fertility treatment providers of module (d) may actively select or recruit users of the interactive user interface to participate in reduced priced diagnostics or treatment packages based upon the information provided by the user in modules (a) and (b) and the user's selection of fertility treatments from module (c).

12. The system of claim 11, wherein the two-way matching is determined by factors selected from the group consisting of: a likelihood that a user will proceed with a recommended fertility treatment within a specified time period; a likelihood that a user will proceed with a recommended fertility treatment provider within a specified time period; a likelihood that the recommended fertility treatment will achieve a user's fertility goals; a probability that a user will discontinue fertility treatments prior to meeting the user's fertility goals; a probability that a user will discontinue fertility treatments prior to completion of a fertility treatment regimen; a probability that a user will default on payments for fertility treatments already provided by a fertility treatment provider; and a probability that a user will default on fertility treatments committed to the user by the fertility treatment provider.

13. The system of claim 1, further comprising a ranking interface in module (a), wherein the user ranks each item in the questionnaire according to relative importance and the computer platform uses the user's ranking to assist in the determination of the final ranking of the fertility providers.

14. The system of claim 1, further comprising a financial pre-qualification interface based upon the information provided in module (b) of the interactive user interface, wherein pre-qualified users receive personalized treatment options or packages from participating fertility treatment providers of module (d).

15. The system of claim 1, further comprising a fee interface.

16. The system of claim 15, wherein users of the interactive user interface pay to access one or more of the questionnaires of modules (a), (b), and (c) and to receive rankings of fertility treatment providers.

17. The system of claim 15, wherein fertility treatment providers pay for inclusion into module (d).
